(19) United States
(12) Patent Application Publication
(10) Pub. No.: US 2005/0255291 A1
(43) Pub. Date: Nov. 17, 2005

(54) Antiglare laminate

(75) Inventors: Yukimitsu Iwata, Tokyo-To (JP); Koichi Mikami, Tokyo-To (JP); Yoshiko Hattori, Tokyo-To (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 11/083,539

(22) Filed: Mar. 18, 2005

(30) Foreign Application Priority Data
Mar. 29, 2004 (JP) 2004-95669
Mar. 4, 2005 (JP) 2005-60598

(51) Int. Cl. B32B 1/00

(52) U.S. Cl. 428/141; 428/143; 428/156

(57) ABSTRACT

Disclosed is an antiglare laminate comprising: a transparent substrate; and an antiglare layer provided on the transparent substrate, the antiglare layer having a concave-convex outermost surface, a plurality of aggregated parts each having a three-dimensional structure formed of five or more fine particles being present within the antiglare layer, the aggregated parts forming the concave-convex shape without gathering of the plurality of aggregated parts.

### TECHNICAL FIELD

The present invention relates to an antiglare laminate for use in displays such as CRTs and liquid crystal panels.

### BACKGROUND ART

An antiglare laminate is generally disposed on the outermost surface of a display in display devices such as CRTs, PDPs (plasma displays), and LCD (liquid crystal display) panels for suppressing a lowering in visibility caused by reflection of external light and reflection of light from fluorescent lamps and the like. The antiglare laminate is generally realized by forming an antiglare layer having concaves and convexes on a substrate. The antiglare layer having concaves and convexes is generally formed by coating a resin containing a filler such as silicon dioxide (silica) on a surface of a transparent substrate (Japanese Patent Laid-Open Nos. 18706/1994 and 302506/2003). Antiglare layers formed by other conventional methods include a layer formed by forming concaves and convexes using secondary aggregates of amorphous silica such as aggregated silica (see FIG. 1), a layer formed by forming concaves and convexes by a method in which a film having concaves and convexes is laminated and transferred onto a surface of an antiglare layer (shaping treatment), or a layer formed by forming concaves and convexes by adding organic beads to a resin.

In recent years, with expansion of the market of displays typified, for example, by PDPs and LCDs and an increase in size of the displays, an improvement in antiglare properties and other properties has also been required of the antiglare laminate disposed on the outermost surface of the display. In particular, improvements including 1) an improvement in contrast, 2) an improvement in sharpness of transmitted image, 3) a reduction in blurring of characters, and 4) realization of excellent glossy-black feeling (degree of blackness of India ink) in such a state that the display is in a black display state have been required. Further, an increase in size of the display leads to a demand for an increase in size of the antiglare laminate per se used as a surface body. In some cases, however, a lowering in visibility as the display was somewhat observed due to a physical change (for example, denaturalization) of the antiglare laminate caused by the size increase.

A problem of a lowering in visibility of the display caused by an increase in size of the antiglare laminate can be solved by improving the antiglare capability in the antiglare laminate. However, it was difficult to satisfy improvement requirements 1) to 4). That is, the improvement in antiglare properties is generally recognized to be in a contradictory relationship with meeting of improvement requirements 1) to 4), and, thus, the production of an antiglare laminate capable of simultaneously satisfying the improvement in antiglare properties and improvement requirements 1) to 4) has been regarded as difficult. As a result, such antiglare laminates have not existed.

On the other hand, current expansion of the market of displays and an increase in size of displays have led to an urgent need for the development of an antiglare laminate that is for large-size monitors having a medium or low level of resolution of not more than 100 ppi rather than an expensive high-definition monitor having a high level of resolution of not less than 200 ppi, can simultaneously satisfy the requirement for antiglare properties and the improvement requirements 1) to 4) and, at the same time, is inexpensive.

### RELATED APPLICATIONS

This application is a patent application claiming priority based on Japanese Patent Application Nos. 95669/2004 and 60598/2005, and the specification of this application includes the contents of these patent applications.

### DISCLOSURE OF THE INVENTION

The present inventors have found that, in an antiglare layer in an antiglare laminate, when a specific number of fine particles constitute an aggregated part in a three-dimensional structure and a plurality of aggregated parts are present without gathering, excellent antiglare properties are realized and a significant improvement can be realized, for example, in 1) an improvement in contrast, 2) an improvement in sharpness of transmitted image, 3) a reduction in blurring of characters, and 4) realization of excellent glossy-black feeling (degree of blackness of India ink) in such a state that the display is in a black display state. The present invention has been made based on such finding. Accordingly, an object of the present invention is to provide an antiglare laminate that can simultaneously realize excellent antiglare properties and image display quality even in the case of a medium or low level of resolution of not more than 100 ppi.

Thus, according to one aspect of the present invention, there is provided an antiglare laminate comprising:

a transparent substrate; and an antiglare layer provided on said transparent substrate,

the outermost surface of said antiglare layer having a concave-convex shape,

a plurality of aggregated parts each having a three-dimensional structure formed of five or more fine particles being present within said antiglare layer,

said aggregated parts forming said concave-convex shape without gathering of said plurality of aggregated parts.

The antiglare laminate according to the present invention can realize a very low haze value, excellent antiglare properties, and a high level of sharpness, even in the case of a large-size liquid crystal panel having a resolution of about 100 ppi (low level of resolution). Further, by virtue of the realization of lowered haze value, as compared with antiglare laminates capable of coping with high definition, the contrast can be significantly improved, blurring of characters in displays can be eliminated to a considerable extent, and, further, the realization of characteristic concave and convex shapes can realize a very high level of glossy-black feeling (degree of India ink blackness), even when the liquid crystal is in OFF.

### BRIEF DESCRIPTION OF THE DRAWINGS

FIG. 1 is a cross-sectional view of a conventional antiglare laminate;

FIG. 2 is a cross-sectional view showing an embodiment of the antiglare laminate according to the present invention;

FIG. 3 is a cross-sectional view showing a preferred embodiment of the antiglare laminate according to the present invention;

FIG. 4 is an optical photomicrograph of an embodiment of an antiglare layer in the antiglare laminate according to the present invention;

FIG. 5 is an optical photomicrograph of an embodiment of an antiglare layer in the antiglare laminate according to the present invention;

FIG. 6 is an optical photomicrograph of an embodiment of an antiglare layer in the antiglare laminate according to the present invention; and

FIG. 7 is an optical photomicrograph of an embodiment of an antiglare layer in the antiglare laminate according to the present invention.

### BEST MODE FOR CARRYING OUT THE INVENTION

Antiglare Laminate

The antiglare laminate according to the present invention will be explained with reference to FIG. 2. FIG. 2 is a cross-sectional view of the antiglare laminate according to the present invention. An antiglare layer 2 is provided on the upper surface of a transparent substrate 1. This antiglare layer 2 comprises a resin and fine particles 3. In FIG. 2, it is understood that five fine particles 3 constitute one aggregated part, and, in this manner, a plurality of aggregated parts are formed and gather to constitute one three-dimensional aggregated part, and these plurality of aggregated parts are scattered without gathering. As shown in FIG. 2, the plurality of aggregated parts are each an aggregated part having a three-dimensional structure consisting of five fine particles.

Preferably, the plurality of aggregated parts are independently present without gathering and form an islands-sea-type concave-convex form. More preferably, a plurality of fine particles not forming any aggregated part range and are scattered between aggregated parts and aggregated parts to constitute a substantially network structure, whereby concaves and convexes are formed so as to connect the plurality of aggregated parts to each other. In particular, the shape of concaves and convexes formed by the latter is effective in imparting the degree of freedom in design of size regulation.

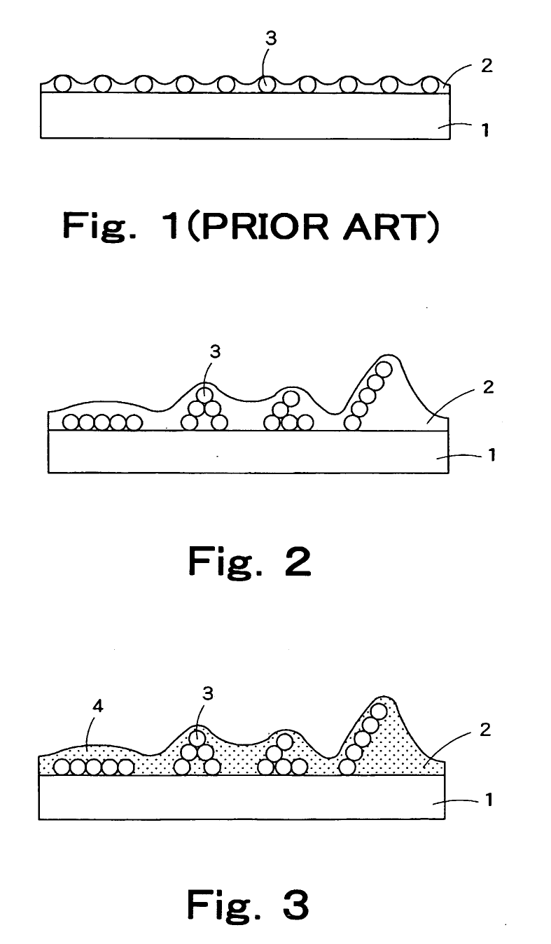

From the above description, it is understood that the aggregated parts of fine particles according to the present invention are different from the conventional antiglare laminate (FIG. 1) in which fine particles are evenly monodispersed and are formed side by side on the outermost surface of the substrate without aggregation. In a preferred embodiment of the present invention, as shown in FIG. 3, an antiglare laminate is proposed in which the antiglare layer in the antiglare laminate according to the present invention comprises fine particles 3 and second fine particles 4 having an average particle diameter different from the fine particles 3.

In the antiglare laminate according to the present invention, the antiglare layer comprises a plurality of aggregated parts each consisting of five or more fine particles. Here the expression “aggregated parts each consisting of five or more fine particles” is a concept including all of such forms that five or more fine particles gather and are superimposed on one another, or that physicochemical properties of the cured resin or the fine particles per se cause aggregation. It is considered that the “aggregated parts each consisting of five or more fine particles” have a three-dimensional structure, and, consequently, concaves and convexes are formed on the outermost surface of the antiglare layer, whereby excellent antiglare properties and image formation can be realized. In the present invention, preferably, in the “aggregated part consisting of five or more fine particles,” the surface is substantially covered by a resin constituting the antiglare layer.

In a preferred embodiment of the present invention, the number of fine particles constituting the aggregated part is 5 or more. Preferably, the upper limit of the number of fine particles constituting the aggregated part is 100, more preferably 50. In the present invention, the aggregated parts do not further gather (including aggregation) and are formed independently of each other within the antiglare layer at given or random intervals.

The antiglare laminate according to the present invention preferably simultaneously satisfies formulae (I) to (III):
8R≦Sm≦30R (I)
R<Hmax≦3R (II)
1.3≦θa≦2.5 (III)
wherein R represents the average particle diameter of said fine particles, μm; Hmax represents the maximum value of the height of the aggregated part in a vertical direction from the substrate surface, μm; Sm represents the average spacing of concaves and convexes in said antiglare layer, μm; and θa represents the average angle of inclination of the concave-convex part.

In a preferred embodiment of the present invention, the following requirements are simultaneously satisfied:
10R≦Sm≦20R (I)
R<Hmax≦2.5R (II)
1.5≦θa≦2.2 (III).

In a more preferred embodiment of the present invention, the following requirements are simultaneously satisfied:
15R≦Sm≦28R (I)
1.2R<Hmax≦2.5R (II)
1.5≦θa≦2.3 (II).

The average spacing Sm of concaves and convexes was determined from a profile curve as measured with a probe surface roughness meter, or the results of three-dimensional measurement with AFM, according to JIS B 0601-1994.

1. Antiglare Layer

(First) Fine Particles/Second Fine Particles

The fine particles and the second fine particles may be spherical, for example, truly spherical or elliptical, preferably truly spherical.

In the present invention, the average particle diameter R (μm) of the fine particles is not less than 2.0 μm (preferably not less than 1.5 μm) and not more than 5.0 μm. Preferably, the upper limit of the average particle diameter is 5.0 μm (preferably 4.6 μm), and the lower limit of the average particle diameter is 3.5 μm (preferably 1.9 μm).

Not less than 95% (preferably not less than 98%) of the whole fine particles is preferably accounted for by fine particles having a particle diameter average distribution of R±0.3 (preferably 0.2) μm. In this case, R is more preferably within the average particle diameter of the fine particles.

In a preferred embodiment of the present invention, the second fine particles different from the fine particles in average particle diameter are further contained. The average particle diameter of the second fine particles is different from the average particle diameter of the fine particles. Further, in a preferred embodiment of the present invention, the antiglare properties in the antiglare layer are not exhibited by the presence of only the second fine particles per se in a simple form or only the aggregated parts per se.

In the present invention, the antiglare laminate preferably satisfies the requirement represented by formula (IV):
0.25R (preferably 0.50)≦r≦1.0R (preferably 0.85R, more preferably 0.70) (IV)
wherein R represents the average particle diameter of the fine particles, μm, and r represents the average particle diameter of the second fine particles, μm.

When r is 0.25 R or more, the dispersion of the coating liquid becomes easy and the particles are not aggregated. Further, in the step of drying after coating, even concaves and convexes can be formed without undergoing an influence of wind at the time of floating. When r is 0.85 R or less, the function of the fine particles can be advantageously clearly distinguished from the function of the first particles. Further, since r is 1.0 R or less, in forming the concaves and convexes, the first particles and the second particles may also be identical to each other in size and composition. Furthermore, when the first particles and the second particles have the same size, they are different from each other in composition (for example, in highly polar resin component (hydrophilic), it is possible that the first particles are hydrophilic particles while the second particles are hydrophobic particles, or the first particles are hydrophobic particles while the second particles are hydrophilic particles), from the viewpoint of regulating the level of aggregation of concaves and convexes.

In another embodiment of the present invention, there is provided an antiglare laminate that satisfies formulae (V) and (VI) regarding the total weight ratio per unit area of said resin, said fine particles, and said second fine particles:
0.08≦(M₁+M₂)/M≦0.36 (preferably 0.28) (V)
0 (preferably 0.2M₁)≦M₂≦5.0M₁ (preferably 4.0M₁) (VI)
wherein M₁ represents the total weight per unit area of said fine particles; M₂ represents the total weight per unit area of said second fine particles; and M represents the total weight per unit area of said resin.

In still another preferred embodiment of the present invention, there is provided an antiglare laminate that satisfies formula (VII):
Δn=¦n₁−n₃¦<0.15 (preferably 0.1) and/or
Δn=¦n₂−n₃¦<0.18 (preferably 0.1) (VII)
wherein n₁, n₂ and n₃ represent the refractive index of said fine particles, the refractive index of said second fine particles, and the refractive index of said resin or the resin matrix, and wherein the haze value within the antiglare laminate is not more than 60% (preferably 55%).

In the present invention, the “resin matrix” refers to a resin system in which fine particles having a particle diameter which is satisfactorily smaller than the wavelength of light are homogeneously dispersed in a resin to vary the refractive index. For example, in the case of a dispersion comprising an inorganic filler as the fine particles (for example, zirconia, refractive index n=around 2.0, particle diameter=around 60 nm) dispersed in a resin (refractive index n=1.51), the dispersion behaves as an optically homogeneous material. The refractive index n of the dispersion may be regulated in a range of 1.55 to 1.69 by varying the content of the inorganic filler. This dispersion is called “resin matrix.”

Inorganic or organic fine particles may be mentioned as the fine particles. Preferably, the fine particles are formed of an organic material. The fine particles exhibit antiglare properties, preferably transparent. Specific examples of fine particles include silica beads as the inorganic fine particles and plastic beads as organic fine particles. The plastic beads are more preferably transparent. Specific examples of plastic beads include styrene beads (refractive index 1.59), melamine beads (refractive index 1.57), acryl beads (refractive index 1.49), acryl-styrene beads (refractive index 1.54), polycarbonate beads, and polyethylene beads. In a preferred embodiment of the present invention, plastic beads having a hydrophobic group-containing surface may be used, and examples thereof include styrene beads.

Resin

The antiglare layer according to the present invention may be formed of a (curing-type) resin. The curing resin is preferably transparent, and three types of resins, that is, ionizing radiation curing resins which are curable by ultraviolet light or electron beam irradiation, mixtures of ionizing radiation curing resins with solvent drying type resins, and heat-curing resins, may be mentioned as specific examples of this resin. Preferred are ionizing radiation curing resins.

Specific examples of ionizing radiation curing resins include resins having an acrylate functional group, and examples thereof include relatively low-molecular weight polyester resins, polyether resins, acrylic resins, epoxy resins, urethane resins, alkyd resins, spiroacetal resins, polybutadiene resins, and polythiol-polyene resins, oligomers or prepolymers of (meth)acrylate or the like of polyfunctional compounds, such as polyhydric alcohols, and ionizing radiation curing resins containing a reactive diluent. Specific examples of reactive diluents usable herein include monofunctional monomers, such as ethyl (meth)acrylate, ethylhexyl (meth)acrylate, styrene, methyl styrene, and N-vinylpyrrolidone, and polyfunctional monomers, for example, polymethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, or neopentyl glycol di(meth)acrylate.

In order to enhance the refractive index of the antiglare layer, preferably, the resin in the antiglare layer according to the present invention may contain an oxide of at least one metal selected from the group consisting of titanium, zirconium, aluminum, indium, zinc, tin, and antimony. In this case, an inorganic filler having an average particle diameter of not more than 0.2 μm, preferably not more than 0.1 μm, more preferably not more than 0.06 μm, may be contained.

The amount of the inorganic filler added is preferably 10 to 90% by mass, more preferably 20 to 80%, particularly preferably 30 to 75%, based on the total mass of solid matter in the antiglare layer. In this filler, since the particle diameter is satisfactorily smaller than the wavelength of light, scattering does not occur, and the dispersion of the filler in the binder polymer functions as an optically homogeneous material.

The refractive index of a bulk of the mixture of the light transparent resin binder with the inorganic filler in the antiglare layer according to the present invention, that is, the refractive index of the antiglare hard coat layer (a matrix thereof) is preferably 1.48 to 1.70, more preferably 1.50 to 1.65, still more preferably 1.52 to 1.62. The refractive index may be brought to the above-defined range by properly selecting the type and the proportion of the amount of the binder and the inorganic filler.

When the ionizing radiation curing resin is used as the ultraviolet curing resin, the use of a photopolymerization initiator is preferred. Specific examples of photopolymerization initiators include acetophenones, benzophenones, Michler's benzoyl benzoate, α-amyloxime esters, tetramethylthiuram monosulfide, and thioxanthones. Further, the use of a mixture of the photopolymerization initiator with a photosensitizer is preferred. Specific examples thereof include n-butylamine, triethylamine, and poly-n-butylphosphine.

The photopolymerization initiator may be a commercially available product. For example, a preferred example of a photocleaving-type photoradical polymerization initiator is Irgacure (184, 907), manufactured by Ciba-Geigy Limited, Japan. The amount-of the photopolymerization initiator added is preferably 0.1 to 10 parts by mass, more preferably 3 to 7 parts by mass, based on 100 parts by mass of the polyfunctional monomer.

Main solvent drying type resins usable as a mixture with the ionizing radiation curing resin are thermoplastic resins which are commonly described and used in the art. The addition of the solvent drying type resin can effectively prevent defects of coating of the coated face.

In a preferred embodiment of the present invention, when the material for the transparent substrate is a cellulosic resin such as TAC, specific examples of preferred thermoplastic resins include cellulosic resins, for example, nitrocellulose, acetylcellulose, cellulose acetate propionate, and ethylhydroxyethylcellulose. The use of the cellulosic resin can improve the adhesion between the transparent substrate and the antistatic layer (optional) and the transparency.

Specific examples of heat curable resins include phenolic resins, urea resins, diallyl phthalate resins, melamine resins, guanamine resins, unsaturated polyester resins, polyurethane resins, epoxy resins, aminoalkyd resins, melamine-urea co-condensed resins, silicone resins, and polysiloxane resins. When heat curable resins are used, if necessary, crosslinking agents, curing agents such as polymerization initiators, polymerization accelerators, solvents, viscosity modifiers and the like may be further added.

2. Transparent Substrate

Preferably, the transparent substrate is smooth and resistant to heat and has excellent mechanical strength. Specific examples of the material for constituting the transparent substrate include thermoplastic resins such as polyester, cellulose triacetate, cellulose diacetate, cellulose acetate butyrate, polyester, polyamide, polyimide, polyether sulfone, polysulfone, polypropylene, polymethyl pentene, polyvinyl chloride, polyvinyl acetal, polyether ketone, polymethyl methacrylate, polycarbonate, and polyurethane. Preferred are polyesters and cellulose triacetate.

In the present invention, these thermoplastic resins are preferably used as a thin, highly flexible film. Depending upon embodiments where curing properties are required, however, plates of thermoplastic resins or glass plates may also be used.

The thickness of the transparent substrate is not less than 20 μm and not more than 300 μm. Preferably, the upper limit of the thickness is 200 μm, and the lower limit of the thickness is 30 μm. When the transparent substrate is in a plate form, the thickness may exceed the above upper limit. In order to improve the adhesion in forming the antiglare layer on the substrate, the substrate may be previously subjected to physical treatment such as corona discharge treatment or oxidation treatment, or coating of a coating material such as an anchoring agent or a primer.

When the antiglare laminate according to the present invention is used in a liquid crystal display device, a pressure-sensitive adhesive layer or the like is applied to one side thereof followed by disposition of the antiglare laminate on the outermost surface of a display. When the transparent substrate is a birefringence-free cellulose acylate film (for example, triacetylcellulose film), triacetylcellulose is used as a protective film for protecting a polarizing layer in a polarizing plate. Therefore, the antiglare laminate according to the present invention as such may be utilized as the protective film, and this is cost effective.

When the antiglare laminate according to the present invention is disposed on the outermost surface of a display after the application of a pressure-sensitive adhesive layer or the like on one side thereof, or as such is used as the protective film for a polarizing plate, preferably, the antiglare laminate is satisfactorily bonded to the object. To this end, preferably, after the formation of other layer such as a low refractive index layer on the transparent substrate, the assembly is subjected to saponification treatment. The saponification treatment may be carried out by a conventional method, for example, by immersing the antiglare laminate according to the present invention in an alikaline solution for a proper period of time. More preferably, after the immersion in the alkaline solution, in order to prevent the alkali component from staying in the laminate, the laminate is subjected to treatment such as thorough washing with water, or immersion in a dilute acid to neutralize the alkali component. The saponification treatment is preferably carried out so that the contact angle of the surface of the transparent substrate remote from the outermost layer with water is not more than 40 degrees, preferably not more than 30 degrees, more preferably not more than 20 degrees. This saponification treatment hydrophilizes the surface of the transparent substrate remote from the low refractive index layer.

The hydrophilized surface is particularly effective because the adhesion to a polarizing film composed mainly of polyvinyl alcohol can be improved. Further, dust in the air is less likely to adhere to the hydrophilized surface. Therefore, in bonding to a polarizing film, dust is less likely to enter a portion between the polarizing film and an antireflective film, and, thus, point defects caused by dust can be effectively prevented.

Formation of Antiglare Laminate

The method for the formation of the antiglare laminate according to the present invention will be described. However, it should be noted that the method for antiglare laminate formation is not limited to this method only.

The antiglare layer may be formed by mixing a resin and fine particles (second fine particles) in a proper solvent, for example, toluene, xylene, cyclohexane, ethyl acetate, butyl acetate, propyl acetate, MEK, MIBK, and cyclohexanone to prepare a composition which is then coated onto a transparent substrate.

In a preferred embodiment of the present invention, a leveling agent, for example, a fluorine or silicone leveling agent, is added to the liquid composition. In the liquid composition with the leveling agent added thereto, upon coating or drying of the coating, the inhibition of curing by oxygen on the surface of the coating can be effectively prevented, and, at the same time, the anti-scratch effect can be imparted. The leveling agent is preferably utilized in transparent substrates in a film form where heat resistance is required (for example, triacetylcellulose).

Methods usable for coating the liquid composition on the transparent substrate include roll coating, Mayer-bar coating, and gravure coating. After coating of the liquid composition, drying and ultraviolet curing are carried out. Specific examples of ultraviolet light sources include light sources such as ultrahigh pressure mercury lamps, high pressure mercury lamps, low pressure mercury lamps, carbon arc lamps, blacklight fluorescent lamps, and metal halide lamps. The wavelength of the ultraviolet light may be in a wavelength range of 190 to 380 nm. Specific examples of electron beam sources include various electron beam accelerators, for example, Cockcroft-Walton, van de Graaff, resonance transformer, insulated core transformer, linear, dynamitron, and high-frequency electron beam accelerators.

The resin is cured, and five or more fine particles in the resin are aggregated to provide a desired concave-convex form on the outermost surface of the antiglare layer.

The thickness of the antiglare layer is not less than 0.5 μm and not more than 10 μm. Preferably, the lower limit of the thickness is 1 μm (preferably 2 μm), and the upper limit of the thickness is 7 μm. Therefore, the antiglare laminate in the present invention may be formed as a film.

3. Optional Layer (Antistatic Layer)

In a preferred embodiment of the present invention, an antistatic layer (electrically conductive layer) may be formed between the transparent substrate and the antiglare layer. The antistatic layer (electrically conductive layer) may be formed on the upper surface of the antiglare layer.

Specific examples of methods usable for antistatic layer formation are one in which a vapor-deposited film is formed by vapor-depositing or sputtering an electrically conductive metal, an electrically conductive metal oxide or the like onto the upper surface of an antiglare layer, and one in which a coating is formed by coating a resin composition comprising electrically conductive fine particles dispersed in a resin.

Antistatic Agent

When the antistatic layer is formed as a vapor-deposited film, antistatic agents usable herein include electrically conductive metals or electrically conductive metal oxides, for example, antimony-doped indium tin oxide (hereinafter referred to as “ATO”) and indium tin oxide (hereinafter referred to as “ITO”). The thickness of the vapor-deposited film as the antistatic layer is not less than 10 nm and not more than 200 nm. Preferably, the upper limit of the thickness is 100 nm, and the lower limit of the thickness is 50 nm.

The antistatic layer may be formed by a coating liquid containing conductive fine particles as an antistatic agent. Specific examples of conductive fine particles include conductive fine particles of a metal or a metal oxide or an organic compound, for example, fine particles of antimony-doped indium tin oxide (hereinafter referred to as “ATO”), indium tin oxide (hereinafter referred to as “ITO”), and organic compounds which had been surface treated with gold and/or nickel. Fine particles (inorganic or organic fine particles) before the surface treatment may be selected from the group consisting of silica, carbon black, metal particles, and resin particles.

The amount of the conductive fine particles added is not less than 5% by weight and not more than 70% by weight, based on the total weight of the antistatic layer. Preferably, the upper limit of the amount of the conductive fine particles added is 60% by weight, and the lower limit is 15% by weight. The thickness of the coating is not less than 0.05 μm (preferably 0.03 μm) and not more than 2 μm. Preferably, the lower limit of the thickness is 0.1 μm, and the upper limit of the thickness is 1 μm. When the coating thickness is in the above-defined range, the transparency of the antistatic layer can be statisfactory.

Curing Resin

In the present invention, when the coating is formed using conductive fine particles, a curing resin is preferably used. The curing resin may be the same as that used in the formation of the antiglare layer.

Formation of Antistatic Layer

When a coating is formed as the antistatic layer, a coating liquid comprising a curing resin contained in conductive fine particles is coated by a coating method such as roll coating, Mayer-bar coating, or gravure coating. After coating of the coating liquid, drying and ultraviolet curing are carried out.

The ionizing radiation curing resin composition is cured by irradiation with an electron beam or ultraviolet light. In the case of electron beam curing, for example, electron beams having an energy of 100 to 300 KeV are used. On the other hand, in the case of ultraviolet curing, for example, ultraviolet light emitted from light sources such as ultrahigh pressure mercury lamps, high pressure mercury lamps, low pressure mercury lamps, carbon arc, xenon arc, and metal halide lamps, are utilized.

Physical Properties of Antiglare Laminate

In a preferred embodiment of the present invention, there is provided an antiglare laminate simultaneously satisfying the following requirements:

the haze value is 2.0 to 8.0%, and, preferably, the upper limit of the haze value is 6.0% (preferably 5.0%), and the lower limit of the haze value is 3.0%,

the 60-degree gloss value is 35 to 65%, and, preferably, the upper limit of the 60-degree gloss value is 55%, and the lower limit of the 60-degree gloss value is 38%, and

the sharpness of transmitted image is 70 to 200%, and, preferably, the upper limit of the sharpness of transmitted image is 150%, and the lower limit of the sharpness of transmitted image is 90%.

In another preferred embodiment of the present invention, there is provided an antiglare laminate which has a surface resistivity value on the outermost surface of not more than 1.0×10¹³ Ω/□, preferably not more than 5.0×10⁸ Ω/□, preferably not more than 5.0×10⁸ Ω/□.

Antireflective Laminate

In still another preferred embodiment of the present invention, there is provided an antireflective laminate comprising: a transparent substrate; and an antiglare layer and a low refractive index layer having a lower refractive index than the antiglare layer provided in that order on the transparent substrate. In the antireflective laminate, the transparent substrate and the antiglare layer may be the same as those constituting the antiglare laminate according to the present invention.

Therefore, for example, the details of the transparent substrate and the antiglare layer, and the method for forming the antiglare layer on the transparent substrate may be the same as those described above in connection with the antiglare laminate.

Low Refractive Index Layer

The low refractive index layer is formed on the surface of the antiglare layer, and the refractive index of the low refractive index layer is lower than the refractive index of the antiglare layer. In a preferred embodiment of the present invention, the refractive index of the antiglare layer is not less than 1.5, and the refractive index of the low refractive index layer is less than 1.5, preferably not more than 1.45.

Specific examples of the material for constituting the low refractive index layer include silicone-containing vinylidene fluoride copolymers. An example thereof is a resin composition comprising: 100 parts by weight of a fluorine-containing copolymer having a fluorine content of 60 to 70% by weight prepared by copolymerizing a monomer composition containing 30 to 90% by weight of vinylidene fluoride and 5 to 50% by weight of hexafluoropropylene; and 80 to 150 parts by weight of a polymerizable compound containing an ethylenically unsaturated group.

An example of the fluorine-containing copolymer is a copolymer prepared by copolymerizing a monomer composition containing vinylidene fluoride and hexafluoropropylene. The content of vinylidene fluoride and the content of hexafluoropropylene in this monomer composition are 30 to 90% by weight, preferably 40 to 80% by weight, particularly preferably 40 to 70% by weight, and 5 to 50% by weight, preferably 10 to 50% by weight, particularly preferably 15 to 45% by weight, respectively. This monomer composition may further contain 0 to 40% by weight, preferably 0 to 35% by weight, particularly preferably 10 to 30% by weight of tetrafluoroethylene.

The monomer composition for preparing the fluorine-containing copolymer may if necessary contain, for example, not more than 20% by weight, preferably not more than 10% by weight, of other comonomer component. Specific examples of other comonomer components include fluorine atom-containing polymerizable monomers such as fluoroethylene, trifluoroethylene, chlorotrifluoroethylene, 1,2-dichloro-1,2-difluoroethylene, 2-bromo-3,3,3-trifluoroethylene, 3-bromo-3,3-difluoropropylene, 3,3,3-trifluoropropylene, 1,1,2-trichloro-3,3,3-trifluoropropylene, and α-trifluoromethacrylic acid.

The content of the fluorine in the fluorine-containing copolymer obtained from the above monomer composition is preferably 60 to 70% by weight, more preferably 62 to 70% by weight, particularly preferably 64 to 68% by weight. When the fluorine content is in the above-defined range, the solubility of the fluorine-containing copolymer in solvents which will be described later is high. Further, when the fluorine-containing copolymer is contained as a component, a thin film having excellent adhesion, high transparency, low refractive index, and excellent mechanical strength can be formed.

The molecular weight of the fluorine-containing copolymer is preferably 5000 to 200000, particularly preferably 10000 to 100000, in terms of number average molecular weight as determined using polystyrene as a standard. When the fluorine-containing copolymer having the above molecular weight is used, the resultant fluororesin composition becomes a suitable viscosity value and thus surely has suitable coatability.

The refractive index of the fluorine-containing copolymer per se is not more than 1.45, preferably not more than 1.42, more preferably not more than 1.40. When the refractive index is in the above-defined range, the formed thin film has favorable antireflection effect.

In a preferred embodiment of the present invention, “fine particles having voids” are preferably used. The “fine particles having voids” can lower the refractive index while holding the layer strength of the low refractive index layer. In the present invention, the “fine particles having voids” refer to fine particles that form a structure comprising gas filled into fine particles and/or a gas-containing porous structure and, as compared with the refractive index inherent in the fine particles, undergoes a lowering in refractive index which is inversely proportional to the proportion of gas in the fine particles. Further, in the present invention, fine particles which can form a nanoporous structure in at least a part of the interior and/or surface depending upon the form of fine particles, structure, aggregated state, and dispersed state of fine particles within the coating.

Specific examples of preferred void-containing inorganic fine particles include silica fine particles prepared by a technique disclosed in Japanese Patent Laid-Open No. 233611/2001. The void-containing silica fine particles can be easily produced and as such have high hardness. Therefore, when the void-containing silica fine particles are mixed with a binder to prepare a mixture which is used for low refractive index layer formation, the layer strength is improved and, in addition, the refractive index can be regulated to a range of about 1.20 to 1.45. In particular, specific examples of preferred void-containing organic fine particles include hollow polymer fine particles prepared by using a technique disclosed in Japanese Patent Laid-Open No. 80503/2002.

Fine particles which can form a nanoporous structure in at least a part of the interior and/or surface of the coating include, in addition to the above-described silica fine particles, controlled release materials which have been produced for increasing the specific surface area and function to adsorb various chemical substances onto a packing column and a porous part on the surface, porous fine particles used for catalyst fixation, or dispersions and aggregates of hollow fine particles for incorporation in heat insulating materials and low dielectric materials. Specifically, such fine particles having a particle diameter falling within a preferred particle diameter range in the present invention may be utilized from commercially available products, for example, aggregates of porous silica fine particles from Nipsil (tradename) and Nipgel (tradename) manufactured by Nippon Silica industrial Co., Ltd., and colloidal silica UP series (tradename) manufactured by Nissan Chemical Industry Ltd. having a structure that silica fine particles are connected to one another in a chain form.

The average particle diameter of the “void-containing fine particles” is not less than 5 nm and not more than 300 nm. Preferably, the lower limit of the average particle diameter is 8 nm, and the upper limit of the average particle diameter is 100 nm. More preferably, the lower limit of the average particle diameter is 10 nm, and the upper limit of the average particle diameter is 80 nm. When the average particle diameter of the fine particles is in the above-defined range, excellent transparency can be imparted to the low refractive index layer.

Formation of Low Refractive Index Layer

A coating may be formed through polymerization by applying an actinic radiation to a fluorine-containing copolymer and a resin optionally in the presence of a photopolymerization initiator, or by heating in the presence of a thermal polymerization initiator. The resin used may be the same as that described above in connection with the antiglare layer.

The amount of the resin added is 30 to 150 parts by weight, preferably 35 to 100 parts by weight, particularly preferably 40 to 70 parts by weight, based on 100 parts by weight of the fluorine-containing copolymer. The content of fluorine in the total amount of the polymer forming component comprising the fluorine-containing copolymer and the resin is 30 to 55% by weight, preferably 35 to 50% by weight.

When the addition amount or the fluorine content is in the above-defined range, the low refractive index layer has good adhesion to the substrate, and, in addition, the refractive index is so high that good antireflective effect can be attained.

In forming the low refractive index layer, preferably, a proper solvent is if necessary used to bring the viscosity of the resin composition to 0.5 to 5 cps (25° C.), preferably 0.7 to 3 cps (25° C.), which can realize good coatability. In this case, an antireflective film having good visible light reflection can be realized, and a thin film can be evenly formed without uneven coating. Further, a low refractive index layer which is particularly excellent in adhesion to the substrate can be formed.

Means for curing the resin may be the same as that explained above in connection with the antiglare layer. When heating means is utilized for curing treatment, a thermal polymerization initiator, which can generate, for example, radicals upon heating to initiate the polymerization of a polymerizable compound, is preferably added to the fluororesin composition.

The thickness of the low refractive index layer is not less than 20 nm and not more than 800 nm. Preferably, the upper limit of the thickness is 400 nm, and the lower limit of the thickness is 50 nm.

In the present invention, the thickness (nm) dA of the low refractive index layer preferably satisfies formula:
d_{A}=mλ/(4n_{A})
wherein

n_{A} represents the refractive index of the low refractive index layer;

m is a positive odd number and is usually 1; and

λ represents wavelength and is 480 to 580 nm.

Further, in the present invention, from the viewpoint of reducing the reflectance, the low refractive index layer preferably satisfies formula:
120<n_{A}d_{A}<145.

Imparting Electrically Conductive Properties

In a preferred embodiment of the present invention, conductive fine particles may be added to the antiglare layer to provide an antireflective laminate having an outermost surface which has been rendered electrically conductive. The conductive fine particles and the method for the addition of the conductive fine particles may be the same as those described above in connection with the antistatic layer.

Polarizing Plate

According to another aspect of the present invention, there is provided a polarizing plate comprising a polarizing element and the antiglare laminate or the antireflective laminate according to the present invention. More specifically, there is provided a polarizing plate comprising: a polarizing element; and either the antiglare laminate according to the present invention provided on the surface of the polarizing element so that the surface opposite to the surface of an antiglare layer in said antiglare laminate faces the surface of said polarizing element, or the antireflective laminate according to the present invention provided on the surface of the polarizing element so that the surface opposite to the surface of a low refractive index layer in said antireflective laminate faces the surface of said polarizing element.

The polarizing element may be, for example, a polyvinyl alcohol film, a polyvinyl formal film, a polyvinyl acetal film, or an ethylene-vinyl acetate copolymer saponified film, which has been dyed with iodine or a dye and has been stretched. In the lamination, for adhesion enhancement or antistatic purposes, the transparent substrate (preferably triacetylcellulose film) is preferably subjected to saponification treatment.

Image Display Device

According to still another aspect of the present invention, there is provided an image display device. This image display device comprises: a transmission display; and a light source device for irradiating said transmission display from the backside, wherein the antiglare laminate according to the present invention, the antireflective laminate according to the present invention, or the polarizing plate according to the present invention is provided on a surface of said transmission display.

The image display device according to the present invention may basically comprise a light source device (backlight), a display element, and the antiglare laminate according to the present invention. Preferably, the image display device comprises a light source device, a display element, and the antireflective laminate according to the present invention.

One embodiment of the image display device according to the present invention comprises, from the backlight side, a light source device, a polarizing element, a transparent substrate, an image display element, the polarizing plate according to the present invention, and the antireflective laminate according to the present invention.

When the image display device according to the present invention is a liquid crystal display device, a light source in the light source device is applied from the underside of the antireflective laminate. In an STN-type liquid crystal display device, a phase difference plate may be inserted into between the liquid crystal display element and the polarizing plate. An adhesive layer may be if necessary provided between individual layers in this liquid crystal display device.

When the antiglare laminate according to the present invention is used as one side of the surface protective film in the polarizing film, the antiglare laminate can be advantageously used in transmission, reflection, or semitransmission liquid crystal display devices of, for example, twisted nematic (TN), supertwisted nematic (STN), vertical alignment (VA), in-plane switching (IPS), and optically compensated bend cell (OCB) modes.

Applications

The antiglare laminate, antireflective laminate, polarizing plate, or image display device according to the present invention is usable in transmission display devices, particularly in displays such as televisions, computers, word processors and the like, especially is applicable to image display devices such as liquid crystal display devices (LCDs), plasma display panels (PDPs), electroluminescent displays (ELDs), and cathode-ray tube display devices (CRTs). Since the antiglare laminate according to the present invention has a transparent substrate, the substrate side may be bonded to the image display face of the image display device.

Measurement of Numerical Values

In the present invention, the haze value may be measured according to JIS K 7105. An example of equipment used in the measurement is a reflectance/transmittance meter HR-100 (manufactured by Murakami Color Research Laboratory). The total light transmittance of the antiglare laminate may also be measured in the same manner as in the measurement of the haze value.

The 60-degree gloss may be measured with a haze meter (manufactured by Murakami Color Research Laboratory, part number; HM-150). The sharpness of transmitted image was expressed in terms of the total numerical values as measured using four types of optical combs (0.25 mm, 0.5 mm, 1 mm and 2 mm) with an image clarity measuring device (manufactured by Suga Test Instruments Co., Ltd., part number; “ICM-1PD”) according to JIS K 7105. The larger the numerical value, the higher the sharpness of transmitted image. The maximum value of the numerical value is 400.

### EXAMPLES

The following Example further illustrates the contents of the present invention. The present invention, however, is not to be construed as being limited thereto. “Parts” and “%” are by mass unless otherwise specified.

Preparation of Composition For Antiglare Layer

Composition 1 for Antiglare Layer

21.61 parts by mass of pentaerythritol triacrylate (“PETA”, manufactured by Nippon Kayaku Co., Ltd., refractive index 1.51) as an ultraviolet curing resin, 9.28 parts by mass of DPHA (manufactured by Nippon Kayaku Co., Ltd., refractive index 1.51) as an ultraviolet curing resin, 2.61 parts by mass of acryl polymer (manufactured by Mitsubishi Rayon Co., Ltd., molecular weight 75,000), 0.65 part by mass of styrene-acryl polymer (manufactured by The Inctec Inc., molecular weight 65,000), 2.02 parts by mass of Irgacure 184 (manufactured by Ciba-Geigy Limited) as a photocuring initiator, 0.34 part by mass of Irgacure 907 (manufactured by Ciba-Geigy Limited) as a photocuring initiator, and 5.47 parts by mass of acrylic beads (manufactured by Nippon Shokubai Kagaku Kogyo Co., Ltd., particle diameter 1.9 μm, refractive index 1.53) as light transparent first fine particles were provided. Light transparent second fine particles were not used. 0.014 part by mass of a silicone leveling agent 10-28 (manufactured by The Inctec Inc.), 46.40 parts by mass of toluene, and 11.60 parts by mass of cyclohexanone were thoroughly mixed in the above mixture to prepare a coating liquid. This coating liquid was filtered through a polypropylene filter with a pore diameter of 30 μm to prepare composition 1 for an antiglare layer.

Composition 2 for Antiglare Layer

20.82 parts by mass of pentaerythritol triacrylate (PETA) (manufactured by Nippon Kayaku Co., Ltd., refractive index 1.51) as an ultraviolet curing resin, 7.72 parts by mass of DPHA (manufactured by Nippon Kayaku Co., Ltd., refractive index 1.51) as an ultraviolet curing resin, 3.06 parts by mass of acryl polymer (manufactured by Mitsubishi Rayon Co., Ltd., molecular weight 75,000), 1.86 parts by mass of Irgacure 184 (manufactured by Ciba-Geigy Limited) as a photocuring initiator, 0.31 part by mass of Irgacure 907 (manufactured by Ciba-Geigy Limited) as a photocuring initiator, and 8.21 parts by mass of acrylic beads (manufactured by Nippon Shokubai Kagaku Kogyo Co., Ltd., particle diameter 4.6 μm, refractive index 1.52) as light transparent first fine particles were provided. Light transparent second fine particles were not used. 0.013 part by mass of a silicone leveling agent 10-28 (manufactured by The Inctec Inc.), 46.40 parts by mass of toluene, and 11.60 parts by mass of cyclohexanone were thoroughly mixed in the above mixture to prepare a coating liquid. This coating liquid was filtered through a polypropylene filter with a pore diameter of 30 μm to prepare composition 2 for an antiglare layer.

Composition 3 For Antiglare Layer

21.28 parts by mass of pentaerythritol triacrylate (PETA) (manufactured by Nippon Kayaku Co., Ltd., refractive index 1.51) as an ultraviolet curing resin, 8.63 parts by mass of DPHA (manufactured by Nippon Kayaku Co., Ltd., refractive index 1.51) as an ultraviolet curing resin, 3.18 parts by mass of acryl polymer (manufactured by Mitsubishi Rayon Co., Ltd., molecular weight 75,000), 1.96 parts by mass of Irgacure 184 (manufactured by Ciba-Geigy Limited) as a photocuring initiator, 0.33 part by mass of Irgacure 907 (manufactured by Ciba-Geigy Limited) as a photocuring initiator, 4.96 parts by mass of acrylic beads (manufactured by Nippon Shokubai Kagaku Kogyo Co., Ltd., particle diameter 4.6 μm, refractive index 1.53) as light transparent first fine particles, 1.65 parts by mass of acrylic beads (manufactured by Nippon Shokubai Kagaku Kogyo Co., Ltd., particle diameter 3.5 μm, refractive index 1.53) as light transparent second fine particles, 0.013 part by mass of a silicone leveling agent 10-28 (manufactured by The Inctec Inc.), 46.40 parts by mass of toluene, and 11.60 parts by mass of cyclohexanone were thoroughly mixed together to prepare a coating liquid. This coating liquid was filtered through a polypropylene filter with a pore diameter of 30 μm to prepare composition 3 for an antiglare layer.

Composition 4 For Antiglare Layer

21.28 parts by mass of pentaerythritol triacrylate (PETA) (manufactured by Nippon Kayaku Co., Ltd., refractive index 1.51) as an ultraviolet curing resin, 8.63 parts by mass of DPHA (manufactured by Nippon Kayaku Co., Ltd., refractive index 1.51) as an ultraviolet curing resin, 3.02 parts by mass of acryl polymer (manufactured by Mitsubishi Rayon Co., Ltd., molecular weight 75,000), 0.16 part by mass of styrene-acryl polymer (manufactured by The Inctec Inc., molecular weight 65,000), 1.96 parts by mass of Irgacure 184 (manufactured by Ciba-Geigy Limited) as a photocuring initiator, 0.33 part by mass of Irgacure 907 (manufactured by Ciba-Geigy Limited) as a photocuring initiator, 5.62 parts by mass of acrylic beads (manufactured by Nippon Shokubai Kagaku Kogyo Co., Ltd., particle diameter 3.5 μm, refractive index 1.53) as light transparent first fine particles, 0.99 part by mass of acrylic beads (manufactured by Nippon Shokubai Kagaku Kogyo Co., Ltd., particle diameter 3.5 μm, refractive index 1.52) as light transparent second fine particles, 0.013 part by mass of a silicone leveling agent 10-28 (manufactured by The Inctec Inc.), 46.40 parts by mass of toluene, and 11.60 parts by mass of cyclohexanone were thoroughly mixed together to prepare a coating liquid. This coating liquid was filtered through a polypropylene filter with a pore diameter of 30 μm to prepare composition 4 for an antiglare layer.

Composition 5 For Antiglare Layer

20.96 parts by mass of pentaerythritol triacrylate (PETA) (manufactured by Nippon Kayaku Co., Ltd., refractive index 1.51) as an ultraviolet curing resin, 8.02 parts by mass of DPHA (manufactured by Nippon Kayaku Co., Ltd., refractive index 1.51) as an ultraviolet curing resin, 3.10 parts by mass of acryl polymer (manufactured by Mitsubishi Rayon Co., Ltd., molecular weight 75,000), 1.89 parts by mass of Irgacure 184 (manufactured by Ciba-Geigy Limited) as a photocuring initiator, 0.32 part by mass of Irgacure 907 (manufactured by Ciba-Geigy Limited) as a photocuring initiator, 4.81 parts by mass of styrene beads (manufactured by Soken Chemical Engineering Co., Ltd., particle diameter 5.0 μm, refractive index 1.53) as light transparent first fine particles, 2.89 parts by mass of melamine beads (manufactured by Nippon Shokubai Kagaku Kogyo Co., Ltd., particle diameter 1.8 μm, refractive index 1.68) as light transparent second fine particles, 0.013 part by mass of a silicone leveling agent 10-28 (manufactured by The Inctec Inc.), 46.40 parts by mass of toluene, and 11.60 parts by mass of cyclohexanone were thoroughly mixed together to prepare a coating liquid. This coating liquid was filtered through a polypropylene filter with a pore diameter of 30 μm to prepare composition 5 for an antiglare layer.

Composition 6 For Antiglare Layer

Composition 6 for an antiglare layer having the following composition was prepared using a zirconia-containing coating composition (tradename “KZ7973”, manufactured by ]SR Corporation, a resin matrix with a refractive index of 1.69) so that the refractive index of the resin matrix was 1.63. 17.76 parts by mass of pentaerythritol triacrylate (PETA) (manufactured by Nippon Kayaku Co., Ltd., refractive index 1.51) as an ultraviolet curing resin, 19.62 parts by mass of zirconia to be incorporated in the ultraviolet curing resin to develop the resin matrix (zirconia contained in tradename “KZ7973”, manufactured by JSR Corporation, average particle diameter 40 to 60 nm, refractive index 2.0), 1.40 parts by mass of a zirconia dispersing agent (zirconia dispersion stabilizer contained in tradename “KZ7973” which is also manufactured by JSR Corporation), 0.94 part by mass of acryl polymer (manufactured by Mitsubishi Rayon Co., Ltd., molecular weight 40,000), 1.21 parts by mass of Irgacure 184 (manufactured by Ciba-Geigy Limited) as a photocuring initiator, 0.20 part by mass of Irgacure 907 (manufactured by Ciba-Geigy Limited) as a photocuring initiator, 1.81 parts by mass of styrene beads (manufactured by Soken Chemical Engineering Co., Ltd., particle diameter 3.5 μm, refractive index 1.60) as light transparent first fine particles, 2.02 parts by mass of acrylic beads (manufactured by Soken Chemical Engineering Co., Ltd., particle diameter 1.5 μm, refractive index 1.49) as light transparent second fine particles, 0.030 part by mass of a silicone leveling agent 10-28 (manufactured by The Inctec Inc.), 41.76 parts by mass of toluene, 10.44 parts by mass of cyclohexanone, and 2.80 parts by mass of MEK were thoroughly mixed together to prepare a coating liquid. This coating liquid was filtered through a polypropylene filter with a pore diameter of 30 μmm to prepare composition 6 for an antiglare layer.

Composition 7 for Antiglare Layer

Composition 7 for an antiglare layer was prepared by adding, to composition 3 for an antiglare layer, Bright GNR4.6-EH (gold-nickel coated resin beads: manufactured by The Nippon Chemical Industrial Co., Ltd.) as an electrically conductive material (electrically conductive particles) in an amount of 0.1% based on the total amount of the antiglare layer.

Composition 8 For Antiglare Layer

Composition 8 for an antiglare layer was prepared in the same manner as in composition 1 for an antiglare layer, except that the particle diameter of the light transparent first fine particles was changed to 1.5 μm.

Composition 9 For Antiglare Layer

Composition 9 for an antiglare layer was prepared in the same manner as in composition 2 for an antiglare layer, except that the particle diameter of the light transparent first fine particles was changed to 6.0 μm.

Composition 10 For Antiglare Layer

Composition 10 for an antiglare layer was prepared in the same manner as in composition 2 for an antiglare layer, except that the light transparent first fine particles was changed to particles having an average particle diameter of 4.6 μm and a particle size distribution of 4.6±2.0 μm.

Composition 11 for Antiglare Layer

Composition 11 for an antiglare layer was prepared in the same manner as in composition 3 for an antiglare layer, except that-the particle diameter of the light transparent second fine particles was changed to 1.0 μm.

Composition 12 For Antiglare Layer

22.55 parts by mass of pentaerythritol triacrylate (PETA) (manufactured by Nippon Kayaku Co., Ltd., refractive index 1.51) as an ultraviolet curing resin, 11.11 parts by mass of DPHA (manufactured by Nippon Kayaku Co., Ltd., refractive index 1.51) as an ultraviolet curing resin, 3.51 parts by mass of acryl polymer (manufactured by Mitsubishi Rayon Co., Ltd., molecular weight 75,000), 2.21 parts by mass of Irgacure 184 (manufactured by Ciba-Geigy Limited) as a photocuring initiator, 0.37 part by mass of Irgacure 907 (manufactured by Ciba-Geigy Limited) as a photocuring initiator, and 2.23 parts by mass of styrene beads (manufactured by Soken Chemical Engineering Co., Ltd., particle diameter 3.5 μm, refractive index 1.60) as light transparent first fine particles were provided. Light transparent second fine particles were not used. 0.015 part by mass of a silicone leveling agent 10-28 (manufactured by The Inctec Inc.), 46.40 parts by mass of toluene, and 11.60 parts by mass of cyclohexanone were thoroughly mixed in the above mixture to prepare a coating liquid. This coating liquid was filtered through a polypropylene filter with a pore diameter of 30 μm to prepare composition 12 for an antiglare layer.

Composition 13 For Antiglare Layer

19.88 parts by mass of pentaerythritol triacrylate (PETA) (manufactured by Nippon Kayaku Co., Ltd., refractive index 1.51) as an ultraviolet curing resin, 5.90 parts by mass of DPHA (manufactured by Nippon Kayaku Co., Ltd., refractive index 1.51) as an ultraviolet curing resin, 2.81 parts by mass of acryl polymer (manufactured by Mitsubishi Rayon Co., Ltd., molecular weight 75,000), 1.68 parts by mass of Irgacure 184 (manufactured by Ciba-Geigy Limited) as a photocuring initiator, 0.28 part by mass of Irgacure 907 (manufactured by Ciba-Geigy Limited) as a photocuring initiator, and 11.44 parts by mass of styrene beads (manufactured by Soken Chemical Engineering Co., Ltd., particle diameter 3.5 μm, refractive index 1.60) as light transparent first fine particles were provided. Light transparent second fine particles were not used. 0.011 part by mass of a silicone leveling agent 10-28 (manufactured by The Inctec Inc.), 46.40 parts by mass of toluene, and 11.60 parts by mass of cyclohexanone were thoroughly mixed in the above mixture to prepare a coating liquid. This coating liquid was filtered through a polypropylene filter with a pore diameter of 30 μm to prepare composition 13 for an antiglare layer.

Composition 14 For Antiglare Layer

20.13 parts by mass of pentaerythritol triacrylate (PETA) (manufactured by Nippon Kayaku Co., Ltd., refractive index 1.51) as an ultraviolet curing resin, 6.39 parts by mass of DPHA (manufactured by Nippon Kayaku Co., Ltd., refractive index 1.51) as an ultraviolet curing resin, 2.88 parts by mass of acryl polymer (manufactured by Mitsubishi Rayon Co., Ltd., molecular weight 75,000), 1.73 parts by mass of Irgacure 184 (manufactured by Ciba-Geigy Limited) as a photocuring initiator, 0.29 part by mass of Irgacure 907 (manufactured by Ciba-Geigy Limited) as a photocuring initiator, 1.76 parts by mass of acrylic beads (manufactured by Nippon Shokubai Kagaku Kogyo Co., Ltd., particle diameter 4.6 μm, refractive index 1.53) as light transparent first fine particles, 8.82 parts by mass of acrylic beads (manufactured by Nippon Shokubai Kagaku Kogyo Co., Ltd., particle diameter 3.5 μm, refractive index 1.53) as light transparent second fine particles, 0.012 part by mass of a silicone leveling agent 10-28 (manufactured by The Inctec Inc.), 46.40 parts by mass of toluene, and 11.60 parts by mass of cyclohexanone were thoroughly mixed together to prepare a coating liquid. This coating liquid was filtered through a polypropylene filter with a pore diameter of 30 μm to prepare composition 14 for an antiglare layer.

Preparation of Composition For Antistatic Layer

Regarding the material for an antistatic layer, 2.0 g of C-4456 S-7 (ATO-containing electrically conductive ink, manufactured by NIPPON PELNOX CORR; average particle diameter of ATO 300 to 400 nm, solid concentration 45%), 2.84 g of methyl-isobutyl ketone, and 1.22 g of cyclohexanone were added and stirred, and the mixture was then filtered through a polypropylene filter with a pore diameter of 30 μm to prepare a composition for an antistatic layer.

Preparation of Composition For Low Refractive Index Layer

0.85 g of photopolymerization initiator (tradename “JUA701”, manufactured by JSR Corporation) and 65 g of MIBK were added to 34.14 g of a composition for a fluororesin low reflective layer (tradename “TM086”, manufactured by JSR Corporation), and the mixture was stirred and then filtered through a polypropylene filter with a pore diameter of 10 μm to prepare a composition for a low refractive index layer.

### Example 1

An 80 μm-thick triacetylcellulose film (TD80U, manufactured by Fuji Photo Film Co., Ltd.) was provided as a transparent substrate. Composition 1 for an antiglare layer was coated onto the film by a winding wire rod (Mayer bar) for coating, and the coated film was heat dried in an oven of 70° C. for one min to evaporate the solvent. Thereafter, under nitrogen purge (oxygen concentration: not more than 200 ppm), ultraviolet light was applied at an exposure of 100 mJ to cure the coating. Thus, a 6 μm-thick antiglare laminate was prepared. The light transparent first fine particles were acrylic beads having a small particle diameter, and the surface of the particles is hydrophilic. To form an aggregated part having a desired three-dimensional structure, a hydrophobic styrene acrylic polymer (molecular weight: 65,000) was added.

### Example 2

An antiglare laminate was prepared in the same manner as in Example 1, except that composition 2 for an antiglare layer was used. In composition 2 for an antiglare layer, acrylic beads having a hydrophobic surface (which is dispersible in toluene and are aggregated in methanol) and a particle diameter of 4.6 μm were used as the light transparent first fine particles.

### Example 3

An antiglare laminate was prepared in the same manner as in Example 1, except that composition 3 for an antiglare layer was used. In composition 3 for an antiglare layer, in order to form an aggregated part having a desired three-dimensional structure, the particle diameter of the light transparent first fine particles and the particle diameter of the light transparent second fine particles used were made different from each other, and the light transparent first and second fine particles were used as a mixed particle system.

### Example 4

An antiglare laminate was prepared in the same manner as in Example 1, except that composition 4 for an antiglare layer was used. In composition 4 for an antiglare layer, as with Example 3, a mixed particle system of the light transparent first fine particles and the light transparent second fine particles was used. The particle diameter of the light transparent first fine particles and the particle diameter of the light transparent second fine particles were identical to each other and was 3.5 μm. In order to form an aggregated part having a desired three-dimensional structure, however, the light transparent first fine particles were the same hydrophobic acrylic beads as used in Example 2, and the light transparent second fine particles were hydrophilic (having a tendency that is aggregated in toluene and is dispersed in methanol) acrylic beads.

### Example 5

An antiglare laminate was prepared in the same manner as in Example 1, except that composition 5 for an antiglare layer was used. In composition 5 for an antiglare layer, in order to form an aggregated part having a desired three-dimensional structure in the particles other than the acrylic beads, styrene beads were used as the light transparent first fine particles, and melamine beads were used as the light transparent second fine particles.

### Example 6

An antiglare laminate was prepared in the same manner as in Example 1, except that composition 6 for an antiglare layer was used. In composition 6 for an antiglare layer, in order to form an aggregated part having a desired three-dimensional structure in the resin matrix, in the zirconia-containing resin matrix (refractive index: 1.63), styrene beads were used as the light transparent first fine particles, and acrylic beads were used as the light transparent second fine particles. The particle diameter of the light transparent first fine particles and the particle diameter of the light transparent second fine particles were made different from each other, and the light transparent first fine particles and the light transparent second fine particles were used as a mixed particle system.

### Example 7

In Example 7, an antistatic layer (AS layer) was coated on a transparent substrate under the following conditions, and composition 7 for an antiglare layer was coated on the antistatic. layer in the same manner as in Example 3.

Preparation of Antiglare Laminate With Antistatic Layer

A composition for an antistatic layer was coated on triacetylcellulose to a thickness of 1.2 μm. The coating was dried at 70° C. for one min, and, under nitrogen purge, UV (ultraviolet) light was then applied at 54 mj for half curing. Next, composition 7 for an antiglare layer was coated onto the antistatic layer to a thickness of 6 μm. The coating was dried at 70° C. for one min, and, under nitrogen purge, UV light was then applied at 100 mj for curing of the coating.

### Example 8

A low refractive index layer was coated on the antiglare layer with an antistatic layer in Example 7 under the following conditions.

Preparation of Antiglare Laminate with Low Reflective Antistatic Layer

An antiglare laminate with an antistatic layer was prepared in the same manner as in Example 7, except that, regarding UV curing conditions of the antiglare layer in the antiglare laminate with an antistatic layer in Example 7, UV (ultraviolet) light was applied under nitrogen purge at 14 mj for half curing. A low refractive index layer was provided on the antiglare layer in the same manner as in the coating of the above low refractive index layer, except that the composition for a low refractive index layer was used.

### Comparative Example 1

An antiglare laminate was prepared in the same manner as in Example 1, except that composition 7 for an antiglare layer, in which the particle diameter 1.9 μm of the light transparent first fine particles was changed to 1.5 μm, was used.

### Comparative Example 2

An antiglare laminate was prepared in the same manner as in Example 2, except that composition 8 for an antiglare layer, in which the particle diameter 4.6 μm of the light transparent first fine particles was changed to 6.0 μm, was used.

### Comparative Example 3

An antiglare laminate was prepared in the same manner as in Example 2, except that composition 10 for an antiglare layer, in which the monodisperse paticles as the light transparent first fine particles having a particle size distribution of 4.6±0.3 μm were changed to particles having a particle size distribution of 4.6±2.0 μm, was used.

### Comparative Example 4

An antiglare laminate was prepared in the same manner as in Example 3, except that composition 11 for an antiglare layer, in which the particle diameter 3.5 μm of the light transparent second fine particles was changed to 1.0 μm, was used.

### Comparative Example 5

An antiglare laminate was prepared in the same manner as in Example 1, except that composition 12 for an antiglare layer, in which styrene beads having a particle diameter of 3.5 μm were used as the light transparent first fine particles and the total weight ratio per unit area between the resin and the light transparent first fine particles was regulated to 0.06, was used.

### Comparative Example 6

An antiglare laminate was prepared in the same manner as in Example 1, except that composition 13 for an antiglare layer, in which styrene beads having a particle diameter of 3.5 μm were used as the light transparent first fine particles and the total weight ratio per unit area between the resin and the light transparent first fine particles was regulated to 0.40, was used.

### Comparative Example 7

An antiglare laminate was prepared in the same manner as in Example 1, except that composition 13 for an antiglare layer, in which the total weight of the light transparent second fine particles were regulated to be five times the total weight of the light transparent first fine particles, was used.

Formulations of the antiglare laminates prepared in the Examples and Comparative Examples were as summarized in Table 1 below.

TABLE 1

| | | First fine particles | | | | | Second fine particles | | |
|---|---|---|---|---|---|---|---|---|---|
| | | | | Weight ratio | | | | | Weight ratio |
| | | | | between | | | | | between |
| | | | | resin and | | | | | resin and |
| | Composition for | Particle | | particle per | Refractive | Hydrophilic/ | Particle | | particle per |
| | antiglare layer | diameter | Material | unit area | index | hydrophobic | diameter | Meterial | unit area |
| Ex. 1 | Composition 1 | 1.9 μm | PMMA | 0.18 | 1.53 | Hydrophilic | — | — | — |
| | for antiglare | | | | | | | | |
| | layer | | | | | | | | |
| Ex. 2 | Composition 2 | 4.6 μm | ↓ | 0.26 | ↓ | Hydrophobic | — | — | — |
| | for antiglare | | | | | | | | |
| | layer | | | | | | | | |
| Ex. 3 | Composition 3 | 4.6 μm | ↓ | 0.15 | ↓ | ↓ | 3.5 μm | PMMA | 0.05 |
| | for antiglare | | | | | | | | |
| | layer | | | | | | | | |
| Ex. 4 | Composition 4 | 3.5 μm | ↓ | 0.17 | ↓ | ↓ | ↓ | ↓ | 0.03 |
| | for antiglare | | | | | | | | |
| | layer | | | | | | | | |
| Ex. 5 | Composition 5 | 5.0 μm | St | 0.15 | 1.60 | ↓ | 1.8 μm | Melamine | 0.09 |
| | for antiglare | | | | | | | | |
| | layer | | | | | | | | |
| Ex. 6 | Composition 6 | 3.5 μm | ↓ | 0.10 | ↓ | ↓ | 1.5 μm | PMMA | ↓ |
| | for antiglare | | | | | | | | |
| | layer | | | | | | | | |
| Ex. 7 | Composition 7 | 4.6 μm | PMMA | 0.15 | 1.53 | ↓ | 3.5 μm | ↓ | 0.05 |
| | for antiglare | | | | | | | | |
| | layer | | | | | | | | |
| Ex. 8 | Composition 7 | 4.6 μm | ↓ | 0.15 | ↓ | ↓ | ↓ | ↓ | ↓ |
| | for antiglare | | | | | | | | |
| | layer | | | | | | | | |
| Comp. | Composition 8 | 1.5 μm | PMMA | 0.18 | 1.53 | Hydrophilic | — | — | — |
| Ex. 1 | for antiglare | | | | | | | | |
| | layer | | | | | | | | |
| Comp. | Composition 9 | 6.0 μm | ↓ | 0.26 | ↓ | ↓ | — | — | — |
| Ex. 2 | for antiglare | | | | | | | | |
| | layer | | | | | | | | |
| Comp. | Composition 10 | 4.6 ± 2.0 | ↓ | 0.26 | ↓ | ↓ | — | — | — |
| Ex. 3 | for antiglare | (particle | | | | | | | |
| | layer | size | | | | | | | |
| | | distribution) | | | | | | | |
| Comp. | Composition 11 | 4.6 μm | ↓ | 0.15 | ↓ | Hydrophobic | 1.0 μm | PMMA | 0.05 |
| Ex. 4 | for antiglare | | | | | | | | |
| | layer | | | | | | | | |
| Comp. | Composition 12 | 3.5 μm | St | 0.06 | 1.60 | ↓ | — | — | — |
| Ex. 5 | for antiglare | | | | | | | | |
| | layer | | | | | | | | |
| Comp. | Composition 13 | 3.5 μm | ↓ | 0.04 | ↓ | ↓ | — | — | — |
| Ex. 6 | for antiglare | | | | | | | | |
| | layer | | | | | | | | |
| Comp. | Composition 14 | 4.6 μm | PMMA | 0.06 | 1.53 | ↓ | 3.5 μm | PMMA | 0.30 |
| Ex. 7 | for antiglare | | | | | | | | |
| | layer | | | | | | | | |

| | | | | | Composition |
|---|---|---|---|---|---|
| | | | | | of solvent |
| | | | Binder | | Ratio of |
| | Second | | | Addition amount of | toluene to |
| | fine particles | | | hydrophobic | component in |
| | Refractive | Hydrophilic/ | Refractive | polymer (based on | coating |
| | index | hydrophobic | index | binder) | composition |
| Ex. 1 | — | — | 1.51 | 8 wt % PMMA | Toluene:cyclohexanone = 80:20 wt % |
| | | | | polymer (mw. | (42.0 wet. %) |
| | | | | 75000) | |
| | | | | St = 2 wt % PMMA | |
| | | | | polymer (mw. | |
| | | | | 65000) | |
| Ex. 2 | — | — | ↓ | 10 wt % PMMA | ↓ |
| | | | | polymer (mw. | |
| | | | | 75000) | |
| Ex. 3 | 1.53 | Hydrophobic | ↓ | ↓ | ↓ |
| Ex. 4 | 1.52 | ↓ | ↓ | ↓ | ↓ |
| Ex. 5 | 1.68 | ↓ | ↓ | ↓ | ↓ |
| Ex. 6 | 1.49 | ↓ | 1.63 | 10 wt % PMMA | ↓ |
| | | | (Zr-containing | polymer (mw. | |
| | | | resin | 45000) | |
| | | | matrix) | | |
| Ex. 7 | 1.53 | ↓ | 1.51 | ↓ | ↓ |
| Ex. 8 | ↓ | ↓ | ↓ | ↓ | ↓ |
| Comp. | — | — | ↓ | 8 wt % PMMA | ↓ |
| Ex. 1 | | | | polymer (mw. | |
| | | | | 75000) | |
| | | | | St = 2 wt % PMMA | |
| | | | | polymer (mw. | |
| | | | | 65000) | |
| Comp. | — | — | ↓ | 10 wt % PMMA | ↓ |
| Ex. 2 | | | | polymer (mw. | |
| | | | | 75000) | |
| Comp. | — | — | ↓ | ↓ | ↓ |
| Ex. 3 | | | | | |
| Comp. | 1.53 | Hydrophobic | ↓ | ↓ | ↓ |
| Ex. 4 | | | | | |
| Comp. | — | — | ↓ | ↓ | ↓ |
| Ex. 5 | | | | | |
| Comp. | — | — | ↓ | ↓ | ↓ |
| Ex. 6 | | | | | |
| Comp. | 1.53 | Hydrophobic | ↓ | ↓ | ↓ |
| Ex. 7 | | | | | |

Evaluation tests

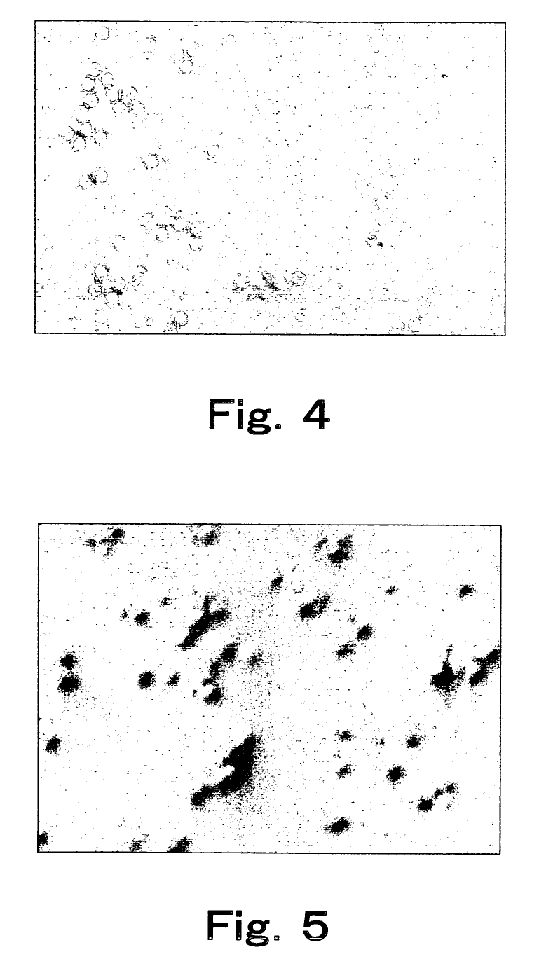

The following evaluation tests were carried out. The results were shown in FIGS. 4 to 7 and Table 2.

Evaluation 1: Planar Shape Evaluation Test

Each of the antiglare laminates prepared in the Examples was mounted in a panel of an image display device, and the surface shape was photographed under an optical microscope (tradename: BX60-F3, manufactured by Olympus Corporation; magnification 200 X). FIG. 4 shows a photograph taken by means of a transmission microscope showing that a plurality of aggregated parts are independently present without gathering. FIG. 5 shows a photograph taken by means of a reflecting microscope. According to the photographs shown in FIGS. 4 and 5, it is understood that a plurality of aggregated parts are independently present without gathering and form an islands-sea-type concave-convex form.

Evaluation 2: Three-Dimensional Structure Evaluation Test

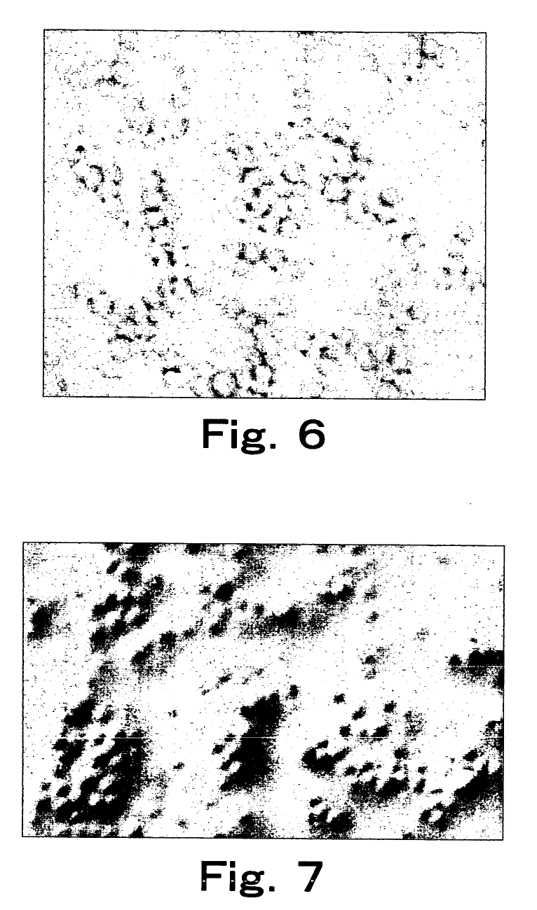

Each of the antiglare laminates prepared in the Examples was mounted in a panel of an image display device, and the surface shape was photographed under an optical microscope (tradename: BX60-F3, manufactured by Olympus Corporation; magnification 200 X). FIG. 6 shows a photograph taken by means of a transmission microscope showing that a plurality of aggregated parts are independently present and a plurality of particles not forming any aggregated part range to constitute a concave-convex form. FIG. 7 shows a photograph taken by means of a reflecting microscope. According to FIGS. 6 and 7, it is understood that a plurality of fine particles not forming any aggregated part range and are scattered between aggregated parts and aggregated parts so that they constitute a substantial network structure and concaves and convexes are formed so as to connect the plurality of aggregated parts to each other.

Evaluation 3: Test For Examining Whether or Not Three-Dimensional Structure Is Present

The antiglare laminates prepared in the Examples and Comparative Examples were measured under an optical microscope in the same manner as in Evaluation 1 and Evaluation 2, and whether or not a three-dimensional structure is present in the antiglare layer was evaluated according to the following criteria.

Evaluation Criteria

ο: A plurality of aggregated parts were independently present without gathering and constituted an islands-see-type concave-convex form.

X: Any three-dimensional structure was not formed due to the presence of aggregated masses, a failure to establish an islands-sea-type concave-convex form, gathering of a plurality of aggregated parts, and the presence of a plurality of aggregated masses derived from poor dispersion of fine particles.

Evaluation 4: Glossy-Black Feeling Test

A cross-nicol polarizing plate was applied to the surface of each of the optical laminates prepared in the Examples and Comparative Examples remote from the antiglare layer. Thereafter, sensory evaluation was carried out under a three-wavelength fluorescent lamp, and the glossy-black feeling (reproduction of India ink black) was evaluated in detail according to the following criteria.

⊚: As a result of observation in all directions, it was found that an image having a glossy-black feeling (reproduction of India ink black) could be realized, and local white parts were hardly found.

ο: As a result of observation in all directions, it was found that an image having a glossy-black feeling (reproduction of India ink black) could be realized, and local white parts, which posed no product problem, were slightly observed.

Δ: As a result of observation in all directions, it was found that whitening was observed as a whole although black parts are locally observed.

X: As a result of observation in all directions, it was found that whitening was observed as a whole.

-: Impossible to observe.

Evaluation 5: Optical Characteristics Test

Haze value (%), 60-degree gloss, and sharpness of transmitted image were measured for the optical laminates prepared in the Examples and the Comparative Examples according to the definition in this specification.

TABLE 2

| | | | Evaluation 5 | | | |
|---|---|---|---|---|---|---|
| | | | | | Sharpness of | |
| | | | | 60-degree gloss | transmitted | Surface |
| | Evaluation 3 | Evaluation 4 | Haze (%) | (%) | image | resistivity |
| Ex. 1 | ◯ | ◯ | 5.2 | 42.3 | 120 | |
| Ex. 2 | ◯ | ◯ | 6.3 | 41.3 | 134 | |
| Ex. 3 | ◯ | ⊚ | 4.3 | 45.7 | 141 | |
| Ex. 4 | ◯ | ⊚ | 3.9 | 39.2 | 127 | |
| Ex. 5 | ◯ | ◯ | 58.0 | 45.8 | 154 | |
| Ex. 6 | ◯ | ◯ | 46.2 | 50.5 | 178 | |
| Ex. 7 | ◯ | ◯ | 4.8 | 43.2 | 123 | |
| Ex. 8 | ◯ | ⊚ | 3.9 | 38.3 | 139 | 2.0 × 10¹² Ω/□ |
| Comp. | X (Formation of large | — | — | — | — | 3.2 × 10¹² Ω/□ |
| Ex. 1 | aggregated masses due to | | | | | |
| | poor dispersion of first fine | | | | | |
| | particles) | | | | | |
| Comp. | X (Planar arrangement) | Δ | 13.4 | 65.9 | 245 | |
| Ex. 2 | | | | | | |
| Comp. | X (Hmax: not less than 3R; | — | 25.6 | 24.3 | 32 | |
| Ex. 3 | whitened) | | | | | |
| Comp. | X (Formation of large | X | — | — | — | |
| Ex. 4 | aggregated masses due to | | | | | |
| | poor dispersion of second | | | | | |
| | fine particles) | | | | | |
| Comp. | X (Planar arrangement) | Δ | 18.0 | 60.3 | 270 | |
| Ex. 5 | | | | | | |
| Comp. | X (Hmax: not less than 3R; | — | 42.0 | 31.2 | 43 | |
| Ex. 6 | fully dispersed) | | | | | |
| Comp. | X (Hmax: not less than 3R; | — | 48.0 | 26.7 | 38 | |
| Ex. 7 | fully dispersed) | | | | | |

1. An antiglare laminate comprising: a transparent substrate; and an antiglare layer provided on said transparent substrate,
the outermost surface of said antiglare layer having a concave-convex shape,
a plurality of aggregated parts each having a three-dimensional structure formed of five or more fine particles being present within said antiglare layer,
said aggregated parts forming said concave-convex shape without gathering of said plurality of aggregated parts.

2. The antiglare laminate according to claim 1, wherein said plurality of aggregated parts are connected to each other by allowing other fine particles not forming said aggregated parts to range.

3. The antiglare laminate according to claim 1, which simultaneously satisfies formulae (I) to (III):
8R≦Sm≦30R (I)
R<Hmax≦3R (II)
1.3≦θa≦2.5 (III)
wherein R represents the average particle diameter of said fine particles, μm; Hmax represents the maximum value of the height of the aggregated parts in a vertical direction from the substrate surface, μm; Sm represents the average spacing of concaves and convexes in said antiglare layer, μm; and θa represents the average angle of inclination of the concave-convex part.

4. The antiglare laminate according to claim 1, wherein said fine particles have a spherical shape, said antiglare layer is formed of a resin, and said aggregated part is substantially covered with said resin.

5. The antiglare laminate according to claim 1, wherein said fine particles are formed of an organic material.

6. The antiglare laminate according to claim 1, wherein the average particle diameter R of said fine particles is not less than 1.5 μm and not more than 5.0 μm, and
not less than 95% of the whole fine particles are accounted for by fine particles of which the particle diameter average distribution is within R±0.3 μm.

7. The antiglare laminate according to claim 1, wherein said antiglare layer further comprises second fine particles which are different from said fine particles in average particle diameter.

8. The antiglare laminate according to claim 7, which satisfies formula (IV):
0.25R≦r≦1.0R (IV)
wherein R represents the average particle diameter of said fine particles; and r represents the average particle diameter of said second fine particles, μm.

9. The antiglare laminate according to claim 7, which satisfies formulae (V) and (VI) regarding the total weight ratio per unit area of said resin, said fine particles, and said second fine particles:
0.08≦(M₁+M₂)/M ≦0.36 (V)
0≦M₂≦5.0M₁ (VI)
wherein M₁ represents the total weight per unit area of said fine particles; M₂ represents the total weight per unit area of said second fine particles; and M represents the total weight per unit area of said resin.

10. The antiglare laminate according to claim 7, wherein said resin is an ionizing radiation curing resin and said second fine particles are formed of an organic material.

11. The antiglare laminate according to claim 7, which satisfies formula (VII):
Δn=¦n₁−n₃¦<0.15 and /or Δn=¦n₂−n₃¦<0.18 (VII)
wherein n₁, n₂ and n₃ represent the refractive index of said fine particles, the refractive index of said second fine particles, and the refractive index of said resin, and wherein the haze value within the antiglare laminate is not more than 60%.

12. The antiglare laminate according to claim 1, which simultaneously satisfies the following requirements:
a haze value of 2.0 to 8.0%,
a 60-degree gloss value of 35 to 65%, and
a sharpness of transmitted image of 70 to 200%.

13. The antiglare laminate according to claim 1, wherein an antistatic layer is further provided between said transparent substrate and said antiglare layer and said antiglare layer contains electrically conductive fine particles, whereby electrical conductivity is imparted to the outermost surface of said antiglare laminate.

14. The antiglare laminate according to claim 13, which has a surface resistivity value of not more than 1.0×10¹³ Ω/□.

15. The antiglare laminate according to claim 1, which is in a film form.

16. An antireflective laminate comprising: an antiglare laminate according to claim 1; and a low refractive index layer which is a lower refractive index than said antiglare layer, provided on the outermost surface of said antiglare laminate.

17. The antireflective laminate according to claim 16, wherein an antistatic layer is further provided between said transparent substrate and said antiglare layer and said antiglare layer contains electrically conductive fine particles, whereby electrical conductivity is imparted to the outermost surface of said antireflective laminate.

18. The antireflective laminate according to claim 16, which has a surface resistivity value of not more than 1.0×10¹³ Ω/□.

19. The antireflective laminate according to claim 16, which is in a film form.

20. A polarizing plate comprising: a polarizing element; and an antiglare laminate according to claim 1 provided so that the surface opposite to the surface of the antiglare layer in said antiglare laminate faces the surface of said polarizing element.

21. An image display device comprising: a transmission display; and a light source device for irradiating said transmission display from the backside, wherein an antiglare laminate according to claim 1 is provided on a surface of said transmission display.

22. A polarizing plate comprising: a polarizing element; and an antireflective laminate according to claim 16 provided so that the surface opposite to the surface of the low refractive index layer in said antireflective laminate faces the surface of said polarizing element.

23. An image display device comprising: a transmission display; and a light source device for irradiating said transmission display from the backside, wherein an antireflective laminate according to claim 16 is provided on a surface of said transmission display.

24. An image display device comprising: a transmission display; and a light source device for irradiating said transmission display from the backside, wherein a polarizing plate according to claim 20 is provided on a surface of said transmission display.
